(19) United States
(12) Patent Application Publication
(10) Pub. No.: US 2011/0128354 A1
(43) Pub. Date: Jun. 2, 2011

(54) SYSTEM AND METHOD FOR OBTAINING CAMERA PARAMETERS FROM MULTIPLE IMAGES AND COMPUTER PROGRAM PRODUCTS THEREOF

(76) Inventors: Tzu-Chieh TIEN, Zhongli City (TW); Po-Hao Huang, Fengshan City (TW); Chia-Ming Cheng, Hsinchu City (TW); Hao-Liang Yang, Pingtung City (TW); Hsiao-Wei Chen, Xinying City (TW); Shang-Hong Lai, Hsinchu City (TW); Susan Dong, Renwu Township (TW); Cheng-Da Liu, Taipei City (TW); Te-Lu Tsai, Taipei City (TW); Jung-Hsin Hsiao, Xindian City (TW)

(21) Appl. No.: 12/637,369

(22) Filed: Dec. 14, 2009

(30) Foreign Application Priority Data
Nov. 27, 2009 (TW) 98140521

(51) Int. Cl. H04N 13/02; G06K 9/34; G06T 15/60

(52) U.S. Cl. 348/50; 382/173; 345/426; 382/260; 348/E13.074

(57) ABSTRACT

Systems and methods for obtaining camera parameters from images are provided. First, a sequence of original images associated with a target object under circular motion is obtained. Then, a background image and a foreground image corresponding to the target object within each original image are segmented. Next, shadow detection is performed for the target object within each original image. A first threshold and a second threshold are respectively determined according to the corresponding background and foreground images. Each original image, the corresponding background image, the first and second threshold are used for obtaining silhouette data and feature information associated with the target object within each original image. At least one camera parameter is obtained based on the entire feature information and the geometry of circular motion.

### CROSS REFERENCE TO RELATED APPLICATIONS

This Application claims priority of Taiwan Application No. 98140521, filed on Nov. 27, 2009, the entirety of which is incorporated by reference herein.

### BACKGROUND OF THE INVENTION

1. Field of the Invention

The invention relates to a technique for obtaining a plurality of camera parameters from a plurality of corresponding images, and more particularly to a technique for obtaining a plurality of camera parameters from a plurality of corresponding two-dimensional (2D) images when the camera parameters of the 2D images are required for constructing a 3D model based on the 2D images.

2. Description of the Related Art

Along with advancements in digital image processing and the popularity of multimedia devices, users are no longer satisfied with plane surfaced or two-dimensional (2D) images. Therefore, demand for displaying three-dimensional (3D) models is increasing. In addition, due to internet technological developments, the demand for on-line gaming, virtual business cities, and digital museum applications . . . etc. have also increased. According, a photorealistic 3D model display technique has been developed, wherein user experience is greatly enhanced when browsing or interacting on the internet.

Conventionally, multiple 2D images are utilized to construct a 3D model/scene having different view angles. For example, a specific or non-specific image capturing apparatus, such as a 3D laser scanner or a general digital camera, can be used to shoot a target object in a fixed image capture angle and image capture position. Afterwards, a 3D model in that scene can be constructed according to the intrinsic and extrinsic parameters of the image capturing apparatus, such as the aspect ratio, the focal length, the image capture angle and image capture position . . . etc.

For the non-specific image capturing apparatus, since the camera parameters are unknown, a user needs to input camera parameters for constructing a 3D model, such as intrinsic and extrinsic parameters of the non-specific image capturing apparatus. However, when the parameters input by the user are inaccurate or wrong, errors may occur when constructing the 3D model. Meanwhile, when using the specific image capturing apparatus for capturing images, since the camera parameters are already known or can be set, a precise 3D model can be constructed without inputting camera parameters or performing any extra alignment. But the drawbacks of using the specific image capturing apparatus are that the image capture angle and position of the image capturing apparatus are fixed and as a result, the size of a target object is limited, and extra costs are required for purchase and maintenance of the specific image capturing apparatus.

Conventionally, some fixed feature points can be marked in a scene, and 2D images of a target object can be captured in different view angles by a common image capturing apparatus, such as a digital camera or video camera, so as to construct a 3D model. However, users still need to input the parameters, and the feature points must be marked in advance for contrasting the target object in the images so as to obtain a silhouette of the target object. When there is no feature point on the target object, or the feature points are not precise enough, the obtained silhouette data is inaccurate, and the constructed 3D model may contain defects, degrading display effect.

Therefore, a system and method for obtaining camera parameters from corresponding images, without using a specific image capturing apparatus or marking any feature points on a target object, are required. The camera parameters should be automatically obtained rapidly and accurately based on the 2D images of a target object. Thus, a user would not be required to input the parameters of the image capturing apparatus. The obtained camera parameters can be used to improve the accuracy and vision effect of the 3D model, and also be used to establish the relationship between images. Additionally, the obtained camera parameter can be used in other image processing techniques, which are expected techniques in the art.

### BRIEF SUMMARY OF THE INVENTION

Systems and methods for obtaining camera parameters from a plurality of images are provided. An exemplary embodiment of a system for obtaining camera parameters from a plurality of images comprises a processing module for obtaining a sequence of original images having a plurality of original images, segmenting a background image and a foreground image corresponding to a target object within each original image, performing shadow detection for the target object within each original image, determining a first threshold and a second threshold according to the corresponding background and foreground images, obtaining silhouette data by using each original image, the corresponding background image and the corresponding first threshold, and obtaining feature information associated with the target object within each original image by using each original image and the corresponding second threshold. Each original image within the sequence of original images is obtained by sequentially capturing the target object under circular motion and the silhouette data corresponds to the target object within each original image, and a calculation module for obtaining at least one camera parameter associated with the original images based on the entire feature information of the sequence of original images and the geometry of circular motion.

In another aspect of the invention, an exemplary embodiment of a method for obtaining camera parameters from a plurality of images comprises: obtaining a sequence of original images having a plurality of original images, wherein each original image within the sequence of original images is obtained by sequentially capturing a target object under circular motion; segmenting a background image and a foreground image corresponding to the target object within each original image; performing shadow detection for the target object within each original image and determining a first threshold and a second threshold according to the corresponding background and foreground images; obtaining silhouette data by using each original image, the corresponding background image and the corresponding first threshold, wherein the silhouette data corresponds to the target object within each original image; obtaining feature information associated with the target object within each original image by using each original image and the corresponding second threshold; and obtaining at least one camera parameter associated with the original images based on the entire feature information of the sequence of original images and the geometry of circular motion.

The method for obtaining camera parameters from a plurality of images may take the form of program codes. When the program codes are loaded into and executed by a machine, the machine becomes an apparatus for practicing the disclosed embodiments.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1A is a block diagram of a system according to an embodiment of the invention;

FIG. 1B is another block diagram of a system according to another embodiment of the invention;

FIG. 2 is a diagram showing the method for capturing images by the image capturing unit according to an embodiment of the invention;

FIG. 3 is a diagram showing the method for capturing images of the target object according to an embodiment of the invention; and

FIG. 4 shows a flow chart of the method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

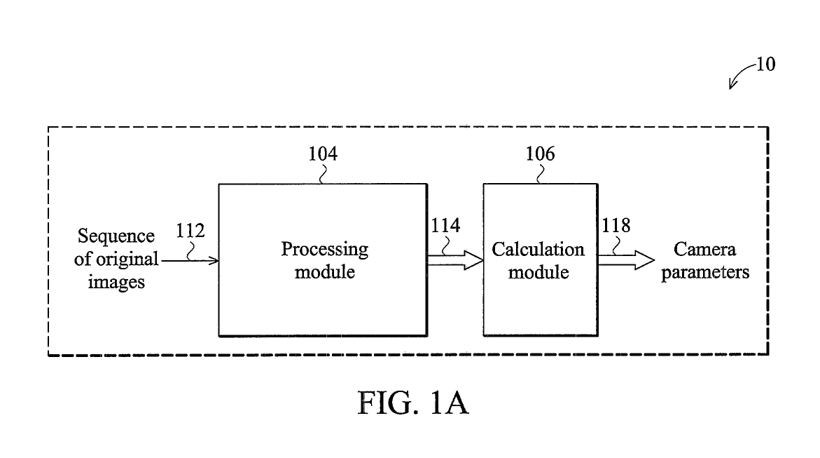

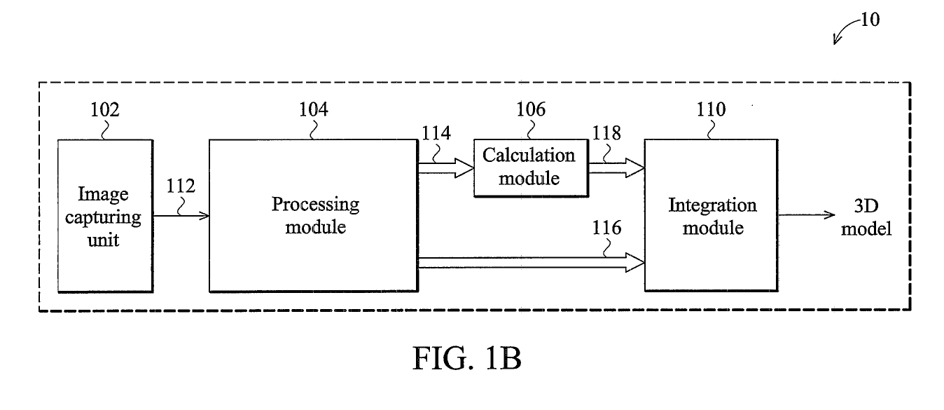

FIG. 1A shows a block diagram of a system 10 according to an embodiment of the invention. As shown in FIG. 1A, the system 10 mainly comprises a processing module 104 and a calculation module 106 for obtaining camera parameters from a plurality of images. In another embodiment of the invention, as shown in FIG. 1B, the system 10 comprises an image capturing unit 102, a processing module 104, a calculation module 106 and an integration module 110.

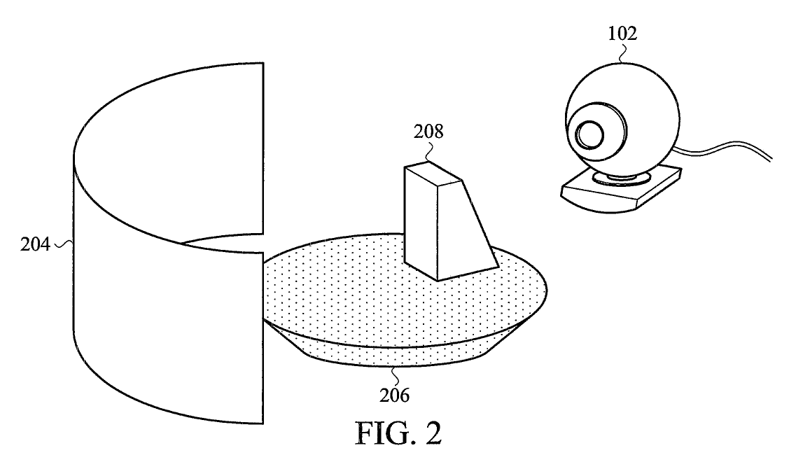

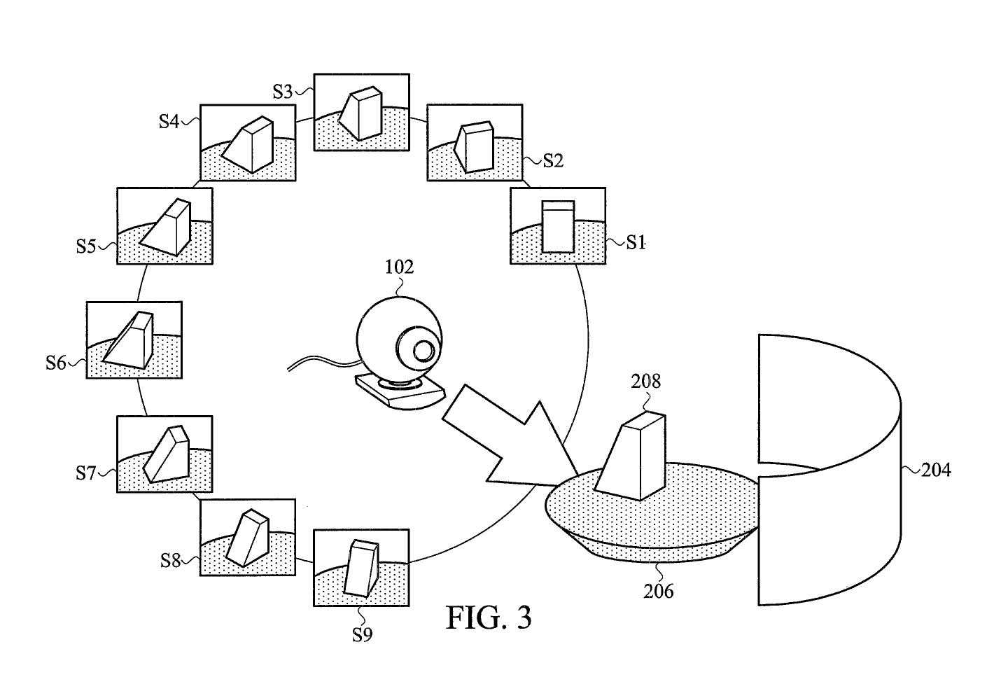

In the embodiment shown in FIG. 1A, the processing module 104 obtains a sequence of original images 112 having a plurality of original images, and segments a skeleton background image and a skeleton foreground image corresponding to a target object within each original image. In the embodiment shown in FIG. 1B, the sequence of original images 112 may be obtained from the output of the image capturing unit 102, such as a charge-coupled device (CCD) camera, to provide the sequence of original images 112 associated with the target object as shown in FIG. 2 and FIG. 3. In another embodiment, the sequence of original images 112 may also be pre-stored in a storage module (not shown in FIG. 1B). The storage module may be a temporary or permanent storage chip, recording media, apparatus or equipment, such as a Random Access Memory (RAM), a Read Only Memory (ROM), a flash memory, a hard disk, a disc (including a Compact Disc (CD), a Digital Versatile Disc (DVD), a Blu-ray Disc (BD)), a magnetic tape and thereof read-write apparatuses.

FIG. 2 is a diagram showing the method for capturing images by the image capturing unit 102 according to an embodiment of the invention. FIG. 3 is a diagram showing the method for capturing images of the target object 208 according to an embodiment of the invention.

Referring to FIG. 2, when capturing the target object 208, the target object 208 is first placed on the turntable 206. In the embodiment, the turntable 206 spins clockwise or counterclockwise at a constant speed via a control module (not shown), so that the target object 208 is under clockwise or counterclockwise circular motion. Further, the image capturing unit 202 is placed outside of the turntable 206 in a fixed location and captures the target object 208. A monochromatic curtain 204 provides a monochromatic background so as to differentiate the target object 208 in the foreground.

When the turntable 206 begins to spin at a constant speed, that is, under the circular motion, the image capturing unit 102 continuously captures the target object 208 under the circular motion in time intervals or at every constant angle, until the turntable 206 has spun a full circle (i.e. 360 degrees), so as to sequentially generate a plurality of original images having the target object 208, as shown in the sequence of original images S1 to S9 in FIG. 3. Each original image in the sequence of original images S1 to S9 provides 2D image data of the target object 208 in different positions and at different view angles.

The number of the original images captured by the image capturing unit 102 may be determined according to the surface feature of the target object 208. As an example, when the number of the original images is high, it means that there are more 2D images obtained in different positions and at different view angles, thereby more accurate geometric information of the target object 208 in the 3D space may be obtained. According to an embodiment of the invention, when the target object 208 has a uniform surface, the number of the original images captured by the image capturing unit 102 may be set to 12, which means that the image capturing unit 102 may capture the target object 208 at every 30 degrees. According to another embodiment of the invention, when the target object 208 has a non-uniform surface, the number of the original images captured by the image capturing unit 102 may be set to 36, which means that the image capturing unit 102 may capture the target object 208 at every 10 degrees.

Note that the target object 208 may be placed in any location as long as it is not outside of the turntable 206.

In addition, note that when the image capturing unit 102 capturing images for the target object 208, the image capturing range need to cover the target object 208 in all images but not the whole turntable 206.

Referring to FIG. 1A and FIG. 1B, after receiving the sequence of the original images 112, the processing module 104 segments a skeleton background image and a skeleton foreground image corresponding to the target object 208 (as shown in FIG. 2 and FIG. 3) for each original image, such as the image S1 shown in FIG. 3.

In an embodiment of the invention, the processing module 104 may first derive an N dimensional Gaussian probability density function from each original image, so as to construct a statistical background model. That is, a multivariate Gaussian model for compiling statistics of the pixels:

$$f ( x ) = {( 2 π )}^{- N / 2} {det ( \sum )}^{- 1 / 2} exp ( - \frac{1}{2} {( x - μ )}^{T} {\sum }^{- 1} ( x - μ ) )$$

where X is the pixel vector of the original image, μ is the mean of the vectors and det(Σ) is the covariance matrix of the probability density function.

After obtaining the skeleton background and foreground images, the processing module 104 performs shadow detection for the target object 208 within each original image. To be more specific, the processing module 104 performs shadow detection for each original image so as to eliminate the effect of background or foreground shadows on the foreground image. This is because when the target object 208 is moving in the scene, shadows may be generated due to the light being covered by the target object 208 or other objects. Shadows cause erroneous judgments when segmenting the foreground image.

In an embodiment of the invention, suppose that the variance in the amount of illumination in a shadow region is identical, the processing module 104 may detect the shadow region according to the angle difference of the color vectors in red, green and blue (RGB) color fields. When the angle between the color vectors of two original images exceeds a predetermined threshold, the specific region may be regarded as the background. In other words, when the angle therebetween is large, it means that the amount of illumination in a specific region is not uniform, and the specific region is the location where the target object 208 is placed. To be more specific, the angle difference of the color vectors may be obtained by using the inner product of the vectors as follows:

$$ang ( {c}_{1} , {c}_{2} ) = acos ( \frac{\vert {c}_{1} \cdot {c}_{2} \vert}{{‖ {c}_{1} ‖}_{2} {‖ {c}_{2} ‖}_{2}} )$$

where c1 and c2 are the color vectors. After obtaining the inner product of two color vectors c1 and c2, the angle between the two color vectors may be obtained via the acos function.

By implementing the above-mentioned shadow detection method, interferences in the foreground caused by target object 208 shadows may be effectively reduced. Specifically, the processing module 104 may determine a first threshold according to the shadow region of each original image and the corresponding skeleton background image. To be more specific, the processing module 104 may perform shadow detection for the skeleton background image according to the above-mentioned method to determine the first threshold. The processing module 104 subtracts the first threshold from the skeleton background image, so as to filter the background image. That is, a more accurate background image may be obtained therefrom. Next, the processing module 104 obtains the entire silhouette data 116 of the target object 208 according to the filtered background image and the corresponding original images.

In addition, the processing module 104 may determine a second threshold according to the shadow region of each original image and the corresponding skeleton foreground image. When operating, the processing module 104 may perform shadow detection for the skeleton foreground image according to the above-mentioned method to determine the second threshold and obtain the feature information 114 corresponding to the original images. After determining the second threshold, the processing module 104 subtracts the second threshold from each original image to obtain the feature information 114 associated with the target object 208.

In the embodiment shown in FIG. 1A, the calculation module 106 receives the feature information 114. Specifically, the calculation module 106 obtains the camera parameters 118 associated with the sequence of the original images 112 based on the entire feature information 114 of the sequence of original images 112 and the geometry of circular motion. In the embodiment shown in FIG. 1B, the sequence of original images 112 is obtained by capturing the target object 208 (as shown in FIG. 2) via the image capturing unit 102. Therefore, the calculation module 106 may obtain the camera parameters 118 used by the image capturing unit 102 when capturing the images. The system 10 as shown in FIG. 1A and FIG. 1B may rapidly and accurately obtain the camera parameters 118 corresponding to the sequence of original images 112 according to the image data provided by the sequence of original images 112.

Specifically, the camera parameters 118 may comprise the intrinsic parameters and extrinsic parameters. Image capturing units 102 in compliance with different specifications may have different intrinsic parameters, such as different aspect ratios, focal lengths, central locations of images, and distortion coefficients . . . etc. In addition, the extrinsic parameters, such as the image capture position or image capture angle when capturing the images, may be obtained according to the intrinsic parameters and the sequence of original images 112. In the embodiments, the calculation module 106 may obtain the camera parameters 118 based on a silhouette-based algorithm. As an example, two sets of image epipoles may be obtained according to the feature information 114 of the original images. Next, the focal length of image capturing unit 102 may be obtained by using the two sets of image epipoles. The intrinsic parameters and extrinsic parameters of the image capturing unit 102 may further be obtained according to the image invariants under circular motion.

Referring to FIG. 1B, the integration module 110 receives the entire silhouette data 116 of the sequence of original images 112 and the camera parameters 118 of the image capturing unit 102 to construct the corresponding three-dimensional model of the target object 208. In an embodiment of the invention, the integration module 110 may obtain the information of the target object 208 in the three dimensional space according to the silhouette data 116 and the intrinsic and extrinsic parameters by using a visual hull algorithm. As an example, the image distortion due to the properties of a camera lens may be recovered through a calibration process. A transformation matrix may be determined according to the camera parameters, such as the extrinsic parameters, of the image capturing unit 102, so as to obtain the geometric relationship between the coordinates in the real space and each pixel in the original images. Next, the calibrated silhouette data may be obtained and the three-dimensional model of the target object 208 may be constructed according to the calibrated silhouette data.

In other embodiments, as the system 10 shown in FIG. 1A, after obtaining the camera parameters 118, the camera parameters 118 may be transmitted to another integration module (not shown in FIG. 1A). The integration module receives the sequence of the original images 112, and calibrates the original images in the sequence of the original images 112 according to the camera parameters 118. Next, a three-dimensional model of the target object 208 is constructed according to the calibrated original images. Specifically, when the image capturing unit 102 captures images, the object is captured via the camera lens, and then projected as the real images. Next, the image distortion due to the property? of the camera lens may be recovered through a calibration process. Next, the image capturing unit 102 determines a transformation matrix according to the camera parameters 118, such as the extrinsic parameters, to obtain the geometric relationship between the coordinates in the real space and each pixel in the original images. In other words, the transformation matrix is utilized in the calibration process so as to transform the image coordinate system of each original image to the World Coordinate System, thereby generating the calibrated original image. Next, the integration module, such as the integration module 110 shown in FIG. 1B, constructs the three-dimensional model according to the calibrated original images.

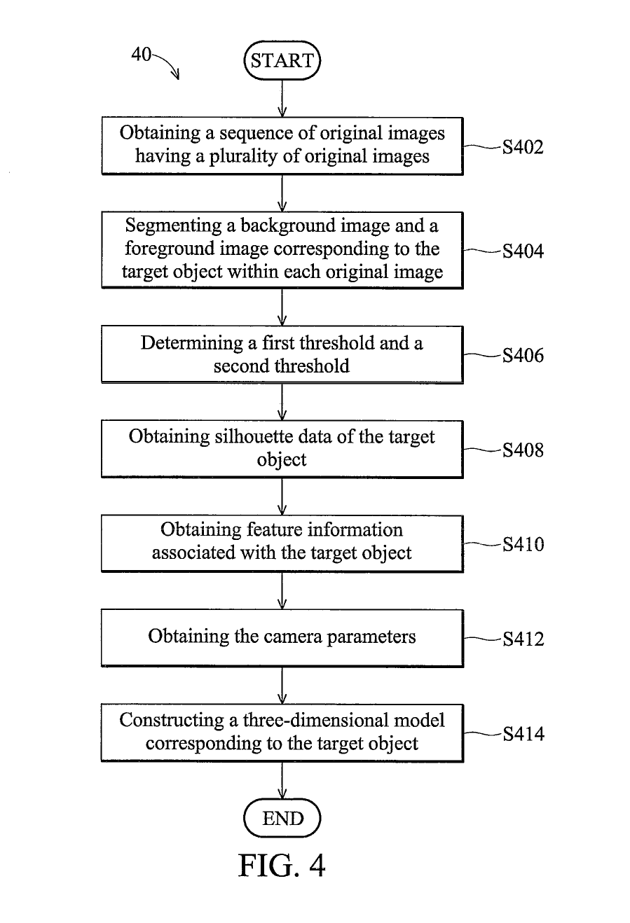

FIG. 4 shows a flow chart of the method 40 according to an embodiment of the invention. Referring to FIG. 1A and FIG. 4, to begin, a sequence of original images 112 having a plurality of original images is obtained (Step S402). In an embodiment of the invention, the sequence of original images 112 may be provided by the image capturing unit 102. In another embodiment of the invention, the sequence of original images 112 may be received from a storage module (not shown in FIG. 1A). As described previously, each original image within the sequence of original images 112 is obtained by sequentially capturing the target object 208 (as shown in FIG. 2 and FIG. 3) under circular motion. The method for capturing images is already illustrated in FIG. 2 and FIG. 3 and the corresponding embodiments, and is omitted here for brevity.

Next, the processing module 104 segments a background image and a foreground image corresponding to the target object 208 within each original image (Step S404).

Next, the processing module 104 performs shadow detection for the target object 208 within each original image. The processing module 104 detects the shadow region in the obtained background image to determine a first threshold. Similarly, the processing module 104 detects the shadow region in the obtained foreground image to determine a second threshold (Step S406). As described previously, by using the two thresholds, the entire silhouette data 116 and the feature information 114 associated with the target object 208 may be obtained.

Specifically, the processing module 104 subtracts the first threshold from the background image to obtain a more accurate background image. Next, the entire silhouette data 116 of the target object 208 within each original image is obtained according to the filtered background image and the corresponding original images (Step S408).

Meanwhile, the processing module 104 determines the second threshold according to the foreground image and the shadow, and subtracts the second threshold from the original image to obtain the feature information 114 associated with the target object 208 (Step S410).

Next, after obtaining the entire feature information of the sequence of original images 112, the calculation module 106 obtains the camera parameters 118, that is, the intrinsic and extrinsic parameters, used when the image capturing unit 102 captures the target object based on the entire feature information of the sequence of original images and the geometry of circular motion (Step S412). Therefore, in the method 40 as shown in FIG. 4, the camera parameters 118 corresponding to the sequence of original images 112 may be rapidly and accurately obtained according to the image data provided by the sequence of original images 112.

Further, referring to FIG. 1B and FIG. 4, the integration module 110 may construct a three-dimensional model corresponding to the target object 208 according to the entire silhouette data 116 of the sequence of original images 112 and the camera parameters 118 of the image capturing unit 102 (Step S414). In an embodiment of the invention, the integration module 110 obtains the information of the target object 208 in the three dimensional space according to the silhouette data 116 and the intrinsic and extrinsic parameters by using a visual hull algorithm.

In conclusion, according to the embodiments of the invention, the conventional problem where errors occur when constructing the 3D model using inaccurate or wrong parameters input by a user can be mitigated without using a specific image capturing apparatus or marking any feature points on the target object. That is, according to the embodiments of the invention, two thresholds may be determined by using the two-dimensional image data of the target object in different positions and at different view angles, so as to obtain the silhouette data required when constructing the three-dimensional model and the camera parameters of the image capturing apparatus when capturing the images. Therefore, the three-dimensional model can be constructed rapidly and accurately.

The system and method system for obtaining camera parameters from a plurality of images, or certain aspects or portions thereof, may take the form of program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements. The separation, combination or arrangement of each module may be made without departing from the spirit of the invention as disclosed herein and such are intended to fall within the scope of the invention.

What is claimed is:

1. A system for obtaining camera parameters from a plurality of images, comprising:
a processing module for obtaining a sequence of original images having a plurality of original images, segmenting a background image and a foreground image corresponding to a target object within each original image, performing shadow detection for the target object within each original image, determining a first threshold and a second threshold according to the corresponding background and foreground images, obtaining silhouette data by using each original image, the corresponding background image and the corresponding first threshold, and obtaining feature information associated with the target object within each original image by using each original image and the corresponding second threshold, wherein each original image within the sequence of original images is obtained by sequentially capturing the target object under circular motion and the silhouette data corresponds to the target object within each original image; and
a calculation module for obtaining at least one camera parameter associated with the original images based on the entire feature information of the sequence of original images and the geometry of circular motion.

2. The system as claimed in claim 1, wherein the at least one camera parameter at least comprises an intrinsic parameter and/or an extrinsic parameter, the intrinsic parameter comprises at least one of a focal length, an aspect ratio, and a central location of each original image, and the extrinsic parameter is obtained according to the intrinsic parameter and the sequence of original images and is at least one of an image capture angle and an image capture position when capturing the target object.

3. The system as claimed in claim 1, further comprising:
an image capturing unit for generating the sequence of original images by capturing the target object when the target object is under circular motion.

4. The system as claimed in claim 3, wherein the image capturing unit generates the sequence of original images by capturing the target object when the target object under the circular motion is at every constant angle.

5. The system as claimed in claim 1, further comprising:
an integration module for constructing a three-dimensional model corresponding to the target object according to the silhouette data of the sequence of original images and the at least one camera parameter.

6. The system as claimed in claim 1, wherein the first threshold is obtained according to a shadow region of each original image and the corresponding background image, and the second threshold is obtained according to the shadow region of each original image and the corresponding foreground image.

7. The system as claimed in claim 1, wherein the processing module segments the background image and the foreground image corresponding to each original image by using a probability density function.

8. The system as claimed in claim 1, further comprising:
an integration module for performing a calibration process on the original images according to the at least one camera parameter and constructing a three-dimensional model corresponding to the target object according to the calibrated original images and the at least one camera parameter.

9. The system as claimed in claim 1, wherein the processing module filters the background image by subtracting the first threshold from the background image and obtains the silhouette data according to each original image and the filtered background image.

10. The system as claimed in claim 1, wherein the processing module obtains the feature information associated with the target object within each original image by subtracting the second threshold from each original image.

11. A method for obtaining camera parameters from a plurality of images, comprising:
obtaining a sequence of original images having a plurality of original images, wherein each original image within the sequence of original images is obtained by sequentially capturing a target object under circular motion;
segmenting a background image and a foreground image corresponding to the target object within each original image;
performing shadow detection for the target object within each original image and determining a first threshold and a second threshold according to the corresponding background and foreground images;
obtaining silhouette data by using each original image, the corresponding background image and the corresponding first threshold, wherein the silhouette data corresponds to the target object within each original image;
obtaining feature information associated with the target object within each original image by using each original image and the corresponding second threshold; and
obtaining at least one camera parameter associated with the original images based on the entire feature information of the sequence of original images and the geometry of circular motion.

12. The method as claimed in claim 11, wherein the at least one camera parameter at least comprises an intrinsic parameter and/or an extrinsic parameter, the intrinsic parameter comprises at least one of a focal length, an aspect ratio, and a central location of each original image, and the extrinsic parameter is obtained according to the intrinsic parameter and the sequence of original images and is at least one of an image capture angle and an image capture position when capturing the target object.

13. The method as claimed in claim 11, further comprising:
providing an image capturing unit for generating the sequence of original images by capturing the target object when the target object is under circular motion.

14. The method as claimed in claim 13, wherein the image capturing unit generates the sequence of original images by capturing the target object when the target object under the circular motion is at every constant angle.

15. The method as claimed in claim 11, further comprising:
constructing a three-dimensional model corresponding to the target object according to the silhouette data of the sequence of original images and the at least one camera parameter.

16. The method as claimed in claim 11, wherein the first threshold is obtained according to a shadow region of each original image and the corresponding background image and the second threshold is obtained according to the shadow region of each original image and the corresponding foreground image.

17. The method as claimed in claim 11, further comprising:
performing a calibration process on the original images according to the at least one camera parameter and constructing a three-dimensional model corresponding to the target object according to the calibrated original images and the at least one camera parameter.

18. The method as claimed in claim 11, wherein the background image is filtered by subtracting the first threshold from the background image and the silhouette data is obtained according to each original image and the filtered background image.

19. The method as claimed in claim 11, wherein the feature information associated with the target object within each original image is obtained by subtracting the second threshold from each original image.

20. A computer program product for being loaded by a machine to execute a method for obtaining camera parameters from a plurality of images, comprising:
a first program code for obtaining a sequence of original images having a plurality of original images, wherein each original image within the sequence of original images is obtained by sequentially capturing a target object under circular motion via an image capturing unit;
a second program code for segmenting a background image and a foreground image corresponding to the target object within each original image;
a third program code for performing shadow detection for the target object within each original image and determining a first threshold and a second threshold according to the corresponding background and foreground images;
a fourth program code for obtaining silhouette data by using each original image, the corresponding background image and the corresponding first threshold, wherein the silhouette data corresponds to the target object within each original image;
a fifth program code for obtaining feature information associated with the target object within each original image by using each original image and the corresponding second threshold; and
a sixth program code for obtaining at least one camera parameter associated with the original images based on the entire feature information of the sequence of original images and the geometry of circular motion.
